(19) United States
(12) Patent Application Publication
(10) Pub. No.: US 2025/0332922 A1
(43) Pub. Date: Oct. 30, 2025

(54) BATTERY ELECTRIC VEHICLE THERMAL MANAGEMENT

(71) Applicant: Deere & Company, Moline, IL (US)

(72) Inventor: Aaron R. Kenkel, Hazel Green, WI (US)

(21) Appl. No.: 18/647,032

(22) Filed: Apr. 26, 2024

(51) Int. Cl. B60L 1/08; B60L 1/00; B60L 58/12

(52) U.S. Cl. CPC B60L 1/08; B60L 1/003; B60L 58/12; B60L 2200/40; B60L 2240/36; B60L 2270/46

(57) ABSTRACT

Disclosed herein are auxiliary systems for work vehicles, and particularly for battery electric work vehicles. Such auxiliary systems can include, for example, heating systems, which may be hydraulic in nature in some examples. Also disclosed herein are methods for controlling such auxiliary systems such that power is conserved when the auxiliary system is not needed, such as, for example, when it is not necessary to thermally control one or more parts of the battery electric work vehicle. According to certain aspects of the disclosure, the control methods involve checking to see whether certain conditions, such as connection to an electrical power source, battery charge level, and system temperature are met, and activating the auxiliary system in response to the conditions being met.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### FIELD

The present disclosure relates to systems for thermal control of the hydraulic system of a work machine, and particularly of a battery electric vehicle work machine.

### BACKGROUND OF THE INVENTION

Battery electric vehicles offer several compelling advantages over vehicles that operate on combustion engines. Particularly, battery electric vehicles can have reduced emissions and greater operational power efficiencies than combustion vehicles. However, in the case of battery electric work vehicles, there are many systems, including drive systems, work tool systems, and operational hydraulics which must all work off of the power stored in the vehicle's batteries.

Hydraulic systems pose a particular challenge in such battery electric vehicles because these systems are temperature sensitive. Particularly, when the temperature of the hydraulic fluid in the hydraulic system is too low, the performance and response speed of the hydraulic system is reduced. It is therefore desirable to provide mechanisms to heat the hydraulic fluid to an optimal operational temperature when the temperature of the hydraulic fluid is too low. However, in the case of battery electric work vehicles, these heating mechanisms and other auxiliary systems are typically powered from the battery, and it may be unfavorable to operate such systems when battery power must be preserved for core vehicle functions.

What is needed, therefore, is a method for controlling auxiliary systems such as a hydraulic warmup system, in such a way as to conserve battery power.

### BRIEF SUMMARY

Disclosed herein are auxiliary systems for battery electric vehicles, such as hydraulic warmup systems, and methods of controlling the same. According to a general example, the auxiliary system may be controlled by a controller unit in response to input from one or more sensors and/or user interfaces. The controller may execute one or more algorithms such as those disclosed herein, to ensure that one or more conditions are met before the auxiliary systems are operated.

Certain examples concern a thermal control method for an auxiliary system of a battery electric vehicle. The thermal control method includes the steps of determining whether the battery electric vehicle is electrically connected to a charging source; measuring a temperature of the auxiliary system; comparing the measured temperature of the auxiliary system against a target temperature; and activating a heating device configured to increase the temperature of the auxiliary system, when the measured temperature is less than the target temperature and when the electric vehicle is electrically connected to the charging source.

Certain examples concern a thermal control system for a hydraulic system of a battery electric vehicle. The thermal control system comprises a pump configured to move a hydraulic fluid within the hydraulic system and a temperature sensor configured to measure the temperature of the hydraulic fluid. The thermal control system also comprises a controller configured to identify when the battery electric vehicle is connected to a charging source, identify the temperature of the hydraulic fluid, compare the temperature of the hydraulic fluid to a target temperature, and activate the pump when the temperature of the hydraulic fluid is less than the target temperature and the battery electric vehicle is connected to a charging source.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a side view of a battery electric vehicle according to one aspect of the present disclosure.

FIG. 2 is a perspective view of the battery electric vehicle of FIG. 1, with the working tool removed.

FIG. 3 is a schematic diagram of a controller system for a battery electric vehicle, according to one aspect of the present disclosure.

FIG. 4 is a schematic diagram of an auxiliary system for a battery electric vehicle, according to one aspect of the present disclosure.

FIG. 5A is a flow chart illustrating a method for the thermal control of an auxiliary system for a battery electric vehicle according to one aspect of the present disclosure.

FIG. 5B is a flow chart illustrating a method for the thermal control of an auxiliary system for a battery electric vehicle according to another aspect of the present disclosure.

### DETAILED DESCRIPTION OF THE INVENTION

### General Terms

The following explanations of terms are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and compounds similar or equivalent to those described herein can be used in the practice or testing of the present disclosure, suitable methods and compounds are described below. The compounds, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

### Introduction to the Disclosed Technology

Disclosed herein are aspects of a battery electric vehicle that includes a hydraulic system, containing a hydraulic fluid, and methods for heating the same. The performance characteristics of the hydraulic fluid, such as the viscosity of the hydraulic fluid, are variable with the temperature of the hydraulic fluid. Accordingly, the temperature of the hydraulic fluid is preferably kept within a certain range. More particularly, when the temperature of the hydraulic fluid is too low, the various hydraulic systems of the vehicle may lose functionality. Such conditions can readily occur when a vehicle is used in a relatively cold environment. Accordingly, a system for warming the hydraulic fluid of a vehicle prior to operating the vehicle is important to ensure performance of the vehicle at a wide range of ambient temperatures and in a wide range of environments.

One method for heating the hydraulic fluid within the hydraulic system of a vehicle, such as a battery electric vehicle, is to pass the hydraulic fluid through a restricted passageway. When the hydraulic fluid is passed through the restricted passageway, it will be heated by the physical resistance. Thus, the hydraulic fluid in a hydraulic system can be heated by running an electrically powered hydraulic pump of the system. It will be readily appreciated however, that other methods can be employed to increase the temperature of the hydraulic fluid, by including one or more auxiliary electrically powered heating systems, such as heating elements.

A particular challenge facing battery electric vehicles is the need to conserve battery power. Contrary to the circumstances facing vehicles with combustion engines capable of generating large quantities of power, power availability on a battery electric vehicle may come at a premium, and it is not generally desirable to consume battery power to heat the hydraulic system to a desirable operational temperature.

The methods disclosed herein for heating the hydraulic system and the hydraulic fluid of battery electric vehicles advantageously run the heating systems (such as a hydraulic pump or heating element), while preventing the expenditure of battery power.

### Aspects of the Disclosed Technology

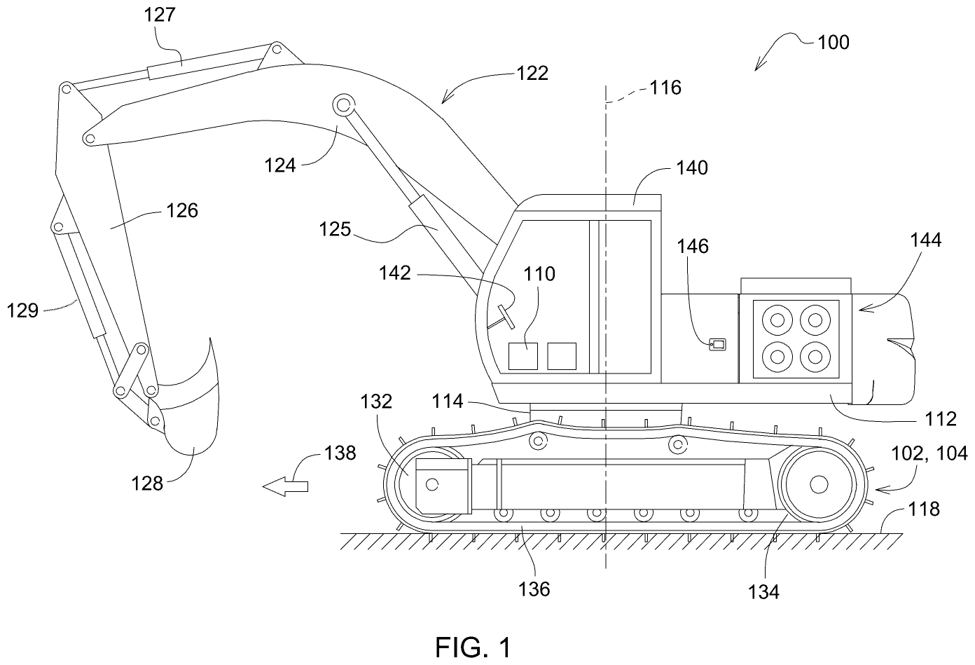

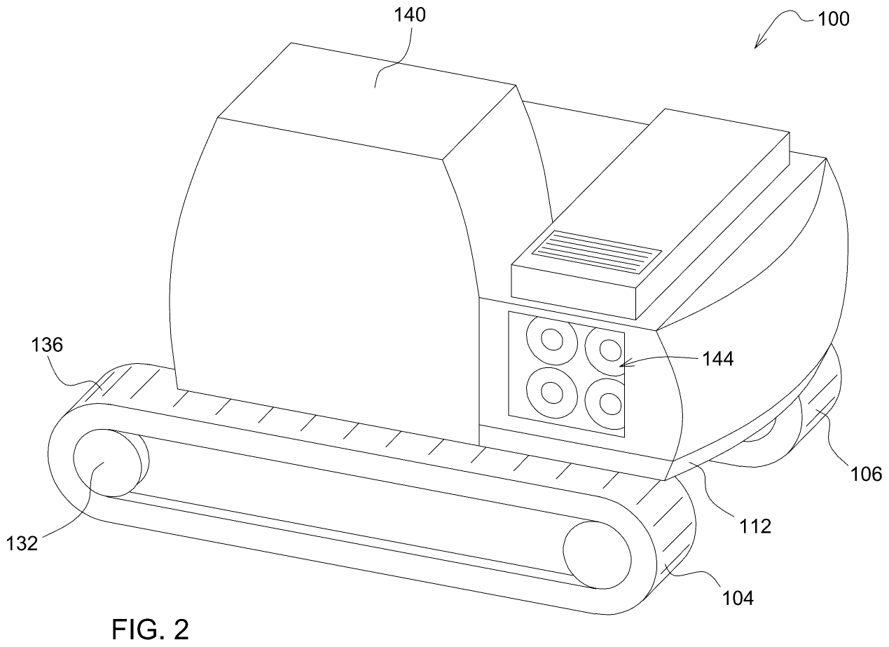

Referring now to the drawings and particularly to FIGS. 1 and 2, a battery electric vehicle 100 is shown. FIG. 1 shows the electric work machine as an electrically powered tracked excavator machine 100. The systems disclosed herein are applicable to excavator machines, feller buncher machines, front shovel machines, and other electrically powered work machines which may be used in the construction and forestry industry. The applicable machines are identifiable by their usefulness in an offroad environment where the machine typically operates in a near stationary manner, and which when travelling typically do so at relatively low speeds, e.g. less than 10 mph. The applicable machines are most often tracked vehicles as opposed to wheeled vehicles.

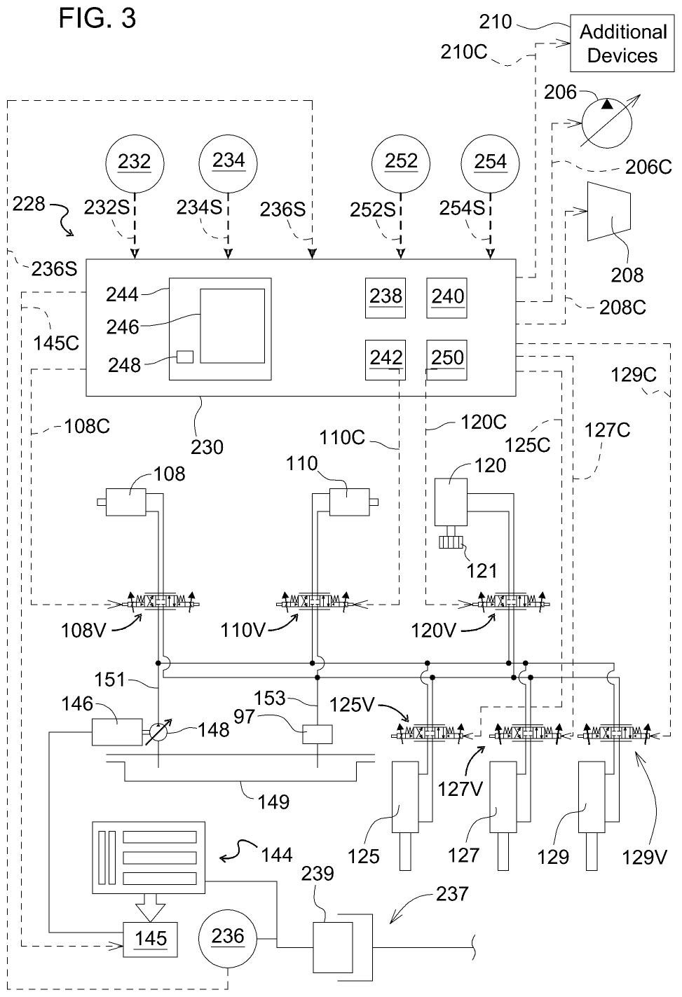

The battery electric vehicle 100 includes an undercarriage 102 including first and second ground engaging units 104 and 106 including first travel motor 108 and second hydraulic travel motor 110 (shown schematically in FIG. 3) for driving the first and second ground engaging units 104 and 106, respectively.

A main frame 112 is supported from the undercarriage 102 by a swing bearing 114 such that the main frame 112 is pivotable about a pivot axis 116 relative to the undercarriage. The pivot axis 116 is substantially vertical when a ground surface 118 engaged by the ground engaging units 104 and 106 is substantially horizontal. A hydraulic swing motor 120 is configured to pivot the main frame 112 on the swing bearing 114 about the pivot axis 116 relative to the undercarriage 102.

The swing bearing 114 includes an upper ring configured to be bolted to the underside of the main frame 112, and a lower ring configured to be bolted to the undercarriage 102. The lower ring includes an internally toothed ring gear. The swing motor 120 is mounted on the main frame 112 and drives a pinion gear 121 which extends downward into engagement with the internally toothed ring gear. Operation of the swing motor 120 drives the pinion gear which results in pivoting movement of the main frame 112 on the swing bearing 114 about the pivot axis 116 relative to the undercarriage 102.

A boom assembly 122 includes a boom 124, an arm 126 pivotally connected to the boom 124, and a working tool 128. Hydraulic actuators 125, 127 and 129 may control the articulated motion of the boom 124, arm 126 and working tool 128, respectively. The boom 124 is pivotally attached to the main frame 112 to pivot about a generally horizontal axis relative to the main frame 112. The working tool in this embodiment is an excavator shovel 128 which is pivotally connected to the arm 126.

In the embodiment of FIG. 1 the first and second ground engaging units 104 and 106 are tracked ground engaging units. Each of the tracked ground engaging units includes a front idler 132, a drive sprocket 134, and a track chain 136 extending around the front idler 132 and the drive sprocket 134. The first travel motor 108 or second travel motor 110 of each tracked ground engaging unit 104 or 106 drives its respective drive sprocket 134. Each tracked ground engaging unit has a forward traveling direction 138 defined from the drive sprocket 134 toward the front idler 132. The forward traveling direction 138 of the tracked ground engaging units also defines a forward traveling direction 138 of the undercarriage 102 and thus of the battery electric vehicle 100.

A cabin 140 may be located on the main frame 112. The cabin 140 and the boom assembly 122 may both be mounted on the main frame so that the cabin 140 faces in a working direction of the boom assembly. A control station 142 may be located in the cabin 140.

Also mounted on the main frame 112 is a battery module 144 for powering the battery electric vehicle 100. The battery module 144 may provide power through a power electronics component 145 to an electric motor 146 driving a hydraulic pump 148 to provide hydraulic power to the various operating systems of the battery electric vehicle 100. The battery module 144, the power electronics component 145, the electric motor 146, the hydraulic pump 148 and the related hydraulic power system for the battery electric vehicle 100 are illustrated schematically in FIG. 3 which is further described below.

FIG. 3 schematically illustrates one embodiment of the electric/hydraulic power supply system of the battery electric vehicle 100 along with a controller 230. In the embodiment illustrated in FIG. 3 electric power from the battery module 144 drives the main electric motor 146 which drives the hydraulic pump 148 which provides hydraulic power to the various hydraulic motors and actuators including travel motors 108 and 110, swing motor 120, and the hydraulic actuators 125, 127 and 129. The hydraulic pump 148 may draw hydraulic fluid from a reservoir 149 and provide pressurized hydraulic fluid to hydraulic fluid supply line 151. Electric/hydraulic control valves 108V, 110V, 120V, 125V, 127V and 129V associated with the motors and actuators 108, 110, 120, 125, 127 and 129, respectively may be controlled by the controller 230 as further described below to control the flow of hydraulic fluid to the motor or actuator as needed. Spent hydraulic fluid is returned to hydraulic fluid return line 153 which returns it to the reservoir 149.

Electric power may also be provided from battery module 144 to various electrically powered accessories of the electric work machine, including the additional devices 210, such as the electrically powered heating elements disclosed herein. In alternative embodiments any one or more of the hydraulic motors and hydraulic cylinders may be replaced by electrically powered actuators which are directly powered by the battery module 144.

The power electronics component 145 may condition the electrical power from the batteries 74A-74C and control the flow of that power to the main electric motor 146 and other electrical accessories under the control of controller 230 as further discussed below.

As schematically shown in FIG. 3, the battery electric vehicle 100 may include the controller 230 operably connected to the hydraulic pump 206, the valve 208 and additional devices 210, such as for example, an electrically powered heating element, as well as other components of the battery electric vehicle 100. As is further described herein the controller 230 may be configured to execute one or more control methods for one or more auxiliary systems, such as heating the hydraulic system, in response to the signals received from one or more sensors and commands according to one or more algorithms.

A hydraulic temperature sensor 232 may be located on one or more portions of a hydraulic loop component of an auxiliary system, so as to measure the temperature of the components of the hydraulic system and/or the hydraulic fluid within the hydraulic system. A hydraulic temperature signal 232S representative of the temperature of the hydraulic system and/or the hydraulic fluid may be transmitted from the hydraulic temperature sensor 232 to the controller 230. Of course, there may be multiple hydraulic temperature sensors 232, one or more of which is associated with different portions, locations, or components of the hydraulic system. The controller 230 may monitor all of the hydraulic temperature sensors 232 and may control based any or all of the temperatures sensed at one of the multiple hydraulic temperature sensors 232.

A valve position sensor 234 may be configured to sense the position of the valve 208, relative to an operational configuration and a non-operational configuration. A valve position signal 234S may be transmitted from valve position sensor 234 to the controller 230.

A charger electrical connection sensor 236 can be configured to determine whether the battery electric vehicle 100 is electrically connected to an electrical charger 237. According to one aspect of the present disclosure, the battery electric vehicle 100 can be connected to the electrical charger 237 by a connector 239 which engages the electrical charger 237 to electrically connect the battery module 144 to the electrical charger 237. In some examples, the charger electrical connection sensor 236 can comprises a mechanical sensor, which detects when the connector 239 physically interconnects with the electrical charger 237. In other examples, the charger electrical connection sensor 236 can comprise an electrical sensor (for example, an ammeter), which detects an electrical current that passes through the connector 239. A charger connection signal 236S may be transmitted from the charger electrical connection sensor 236 to the controller 230.

A battery charge level sensor 252 can be configured to determine how charged the battery (for example, the battery module 144) of the battery electric vehicle 100 is. This measurement may be in terms of a percentage of overall capacity, in terms of a total power capacity stored in the battery, or in terms of expected operational time of the battery electric vehicle 100 use expected from the battery charge. A battery charge signal 252S may be transmitted from the charger electrical connection sensor 236 to the controller 230.

A clock, timer, or chronometer 254 can be configured to track the time of day, in absolute terms or relative to a predetermined schedule. A chronometer signal 254S may be transmitted from the chronometer 254 to the controller 230 and can be used to by the controller 230 to control the activation and/or deactivation of one or more of the systems disclosed herein based on the predetermined schedule.

As schematically illustrated in FIG. 3, the battery electric vehicle 100 includes a control system 228 including the controller 230. The controller 230 may be part of the machine control system of the battery electric vehicle 100, or it may be a separate control module. The controller 230 may be mounted in the cabin 140 at the control station 142. The controller 230 is configured to receive as input signals the hydraulic temperature signal 232S, the ambient valve position signal 234S and the charger connection signal 236S as well as other information regarding the operation of the battery electric vehicle 100. The signals transmitted from the various sensors to the controller 230 are schematically indicated in FIG. 3 by phantom lines connecting the sensors to the controller with an arrowhead indicating the flow of the signal from the sensor to the controller 230.

Similarly, the controller 230 will generate control signals for controlling the operation of the various motors or actuators, which control signals are indicated schematically in FIG. 3 by phantom lines connecting the controller 230 to the various motors or actuators with the arrow indicating the flow of the command signal from the controller 230 to the respective motor or actuator. It will be understood that the various actuators as disclosed herein may be hydraulic motors or may be hydraulic piston-cylinder units and that the electronic control signals from the controller 230 may actually be received by electro-hydraulic control valves 108V, 110V, 120V, 125V, 127V, 129V associated with the motors or actuators and the electro-hydraulic control valves will control the flow of hydraulic fluid to and from the respective hydraulic motors or actuators to control the actuation thereof in response to the control signals from the controller 230. As schematically illustrated in FIG. 3 those electro-hydraulic control valves may be 4-way/3-position spool valves.

Alternatively, the motors actuators may be electric motors or actuators. In such an embodiment the control signals from the controller 230 may activate relays and switches to direct electrical power to the electric motors or actuators to drive the motors or actuators in a desired direction at a desired speed.

The control signal communication lines are designated as 145C, 108C, 110C, 120C, 125C, 127C and 129C for communications with the power electronics component 145, and the control valves 108V, 110V, 120V, 125V, 127V and 129V, respectively. The control signal lines 206C, 208C, and 210C represent control signals sent to the hydraulic pump 206, the valve 208, and the additional devices respectively.

The control signals sent to the hydraulic pump 206 control the activation of and/or speed of the hydraulic pump 206. The control signals sent to the valve 208 control the activation of and/or the speed of the valve 208. The control signals sent to the additional devices 210 control the activation and/or deactivation of additional systems, including, for example, electrically powered heating elements or any other components of an auxiliary system which may be activated or deactivated in response to signals of the controller 230. The control signals may be generated at least in part in response to one or more of the input signals 232S, 234S and 236S.

Controller 230 includes or may be associated with a processor 238, a computer readable medium 240, a database 242 and an input/output module or control panel 244 having a display 246. The control panel 244 may be a part of the control station 142 in the cabin 140. An input/output device 248, such as a keyboard, joystick or other user interface, is provided so that the human operator may input instructions to the controller. It is understood that the controller 230 described herein may be a single controller having all of the described functionality, or it may include multiple controllers wherein the described functionality is distributed among the multiple controllers.

Various operations, steps or algorithms as described in connection with the controller 230 can be embodied directly in hardware, in a computer program product 250 such as a software module executed by the processor 238, or in a combination of the two. The computer program product 250 can reside in RAM memory, flash memory, ROM memory, EPROM memory, EEPROM memory, registers, hard disk, a removable disk, or any other form of computer-readable medium 240 known in the art. An exemplary computer-readable medium 240 can be coupled to the processor 238 such that the processor 238 can read information from, and write information to, the memory/storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

Also disclosed herein are auxiliary systems for the battery electric vehicle 100 and methods for regulating and/or managing the same. The battery electric vehicle 100 can include one or more auxiliary systems that regulate or control one or more functions of the battery electric vehicle 100. In some examples, the auxiliary system may be a thermal control system, such as a hydraulically or electrically heated thermal control system, but it will be appreciated that other auxiliary systems may be included and/or controlled in a similar way.

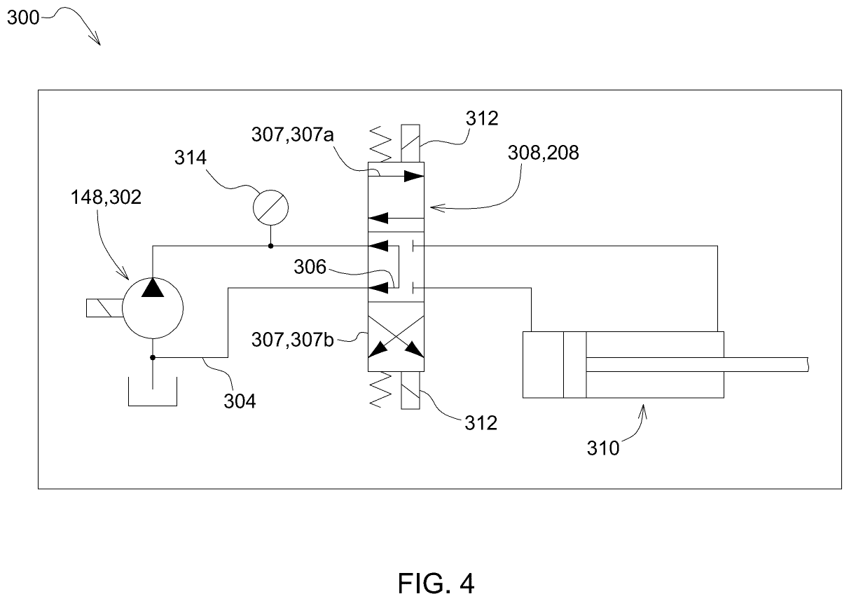

According to some aspects of the present disclosure, the auxiliary system can be a hydraulic system such as the thermal control system 300 that is depicted in FIG. 4. In some examples, the thermal control system 300 schematically depicted in FIG. 4 can be the same hydraulic system previously discussed, including the hydraulic pump 148, the reservoir 149, the hydraulic fluid supply line 151, and the hydraulic fluid return line 153. In other examples, the thermal control system 300 can be a separate hydraulic system with a separate hydraulic pump, reservoir, hydraulic fluid supply line, and hydraulic fluid return line.

The thermal control system 300 be heated by various methods, such as by activating the hydraulic pump to induce a flow of a hydraulic fluid across a restrictive passage, or in other examples, by direct heating, such as may be accomplished by electrically powered heating elements and/or other heating elements in thermal communication with the hydraulic fluid. While reference is made throughout the present disclosure to a thermal control method for a hydraulic system, it will be appreciated that similar logic may apply to any other auxiliary system of the battery electric vehicle 100 that operates under thermal requirements, or whose performance is variable based on the operational temperature of the auxiliary system.

According to some aspects of the present disclosure, the auxiliary system may be a hydraulic system, such as the thermal control system 300 schematically illustrated in FIG. 4. The thermal control system 300 comprises an electrically powered pump, such as hydraulic pump 302 and a hydraulic loop 304. In some aspects of the present disclosure, the hydraulic pump 302 can be the same hydraulic pump 148 previously discussed in relation to FIG. 3, which operates the various hydraulic components of the battery electric vehicle 100. However, in other aspects of the present disclosure, it will be appreciated that the hydraulic pump 302 may be a distinct hydraulic pump (that is, the hydraulic pump 148 may be a first hydraulic pump and the hydraulic pump 302 may be a second hydraulic pump), such that a flow of hydraulic fluid can be introduced without activating the hydraulic pump 148 that operates the main hydraulic components of the battery electric vehicle 100.

The thermal control system 300 further includes a hydraulic fluid contained within the hydraulic loop 304. The performance of the hydraulic fluid may depend on the temperature of the hydraulic fluid, and/or the characteristics of the hydraulic fluid, such as viscosity and flow rate, as a function of the temperature of the hydraulic fluid.

In such examples, it may be possible to heat the hydraulic fluid by passing the hydraulic fluid through a restrictive passage 306. According to some aspects of the present disclosure, the restrictive passage 306 can be defined, or partially defined, by an adjustable valve 308. According to some aspects of the present disclosure, the adjustable valve 308 can be the same valve 208 previously described in relation to the schematic diagram of FIG. 3. It will be appreciated, however, that in other examples, the adjustable valve 308 can be a distinct valve, such that the valve 208 is a first valve and the adjustable valve 308 is a second valve.

The adjustable valve 308 can have one or more operational positions and a non-operational position. According to some aspects of the present disclosure, the adjustable valve 308 is in an operational position when it connects the hydraulic loop 304 to a working load, such as an actuator 310. When the adjustable valve 308 is in such a position, the hydraulic loop 304 acts upon the actuator 310 to perform work. In such circumstances, the hydraulic fluid can flow through an unrestricted passage 307, such as the first unrestricted passage 307a and the second unrestricted passage 307b since it may not be desirable to restrict the flow of hydraulic fluid when the hydraulic loop 304 is operably connected to the actuator 310.

Likewise, the adjustable valve 308 is in the non-operational position when the adjustable valve 308 does not connect the hydraulic loop 304 to any working load. In such a configuration, the adjustable valve 308 can direct the flow of hydraulic fluid across the restrictive passage 306, which may include a channel that is narrower than the hydraulic loop 304, such that the resistance of the restrictive passage 306 heats the hydraulic loop 304. Because, when the adjustable valve 308 is in this configuration, the hydraulic loop 304 is not operably connected to the actuator 310, the working efficiency of the hydraulic system is not impacted even if a restriction, such as the restrictive passage 306 is introduced to the hydraulic loop 304.

According to one aspect of the present disclosure, the movement of the adjustable valve 308 between the operational position and the non-operational position can be controlled by one or more solenoids 312, as shown schematically in FIG. 4. For example, the adjustable valve 308 can have a neutral (that is, non-operational) position in which it is not connected to any load (for example, an actuator 310 such as that shown in FIG. 4. The adjustable valve 308 can also have one or more operational positions. For example, the adjustable valve 308 shown in FIG. 4 can be configured to drive the actuator 310 in a forward (or extending) direction, and a reverse (or retracting) direction, by connecting the hydraulic loop 304 hydraulically with the actuator 310 as shown.

The adjustable valve 308 can be moved between the operational position and the non-operational position in response to one or more signals from the controller 230 (that is, the one or more solenoids 312 can move the adjustable valve 308 between any operational and non-operational positions in response to one or more signals from the controller 230).

In some examples, the controller 230 can transmit the one or more signals in response to measurements or data received from the valve position sensor 234. According to one aspect of the present disclosure, the valve position sensor 234 can be a pressure transducer 314, such as that shown in FIG. 4, which measures the pressure of the hydraulic fluid in the hydraulic loop 304. In such examples, when the adjustable valve 308 is in the operational configuration, and the hydraulic loop 304 is connected to the actuator 310 through an unrestricted passage 307, such as the first unrestricted passage 307a or the second unrestricted passage 307b shown in FIG. 4, the hydraulic fluid may be at a first pressure. When the adjustable valve 308 is in the non-operational configuration and the hydraulic loop 304 is connected to the restrictive passage 306, the hydraulic fluid may be at a second pressure different from the first pressure. By measuring the pressure in the hydraulic loop 304, it is therefore possible to use the pressure transducer 314 to determine the position of the adjustable valve 308.

As previously discussed, the hydraulic fluid in the thermal control system 300 can be heated by running the hydraulic pump 302 and forcing the hydraulic fluid through the restrictive passage 306. However, power to run the hydraulic pump 302, if drawn from the batteries (that is, the battery module 144) of the battery electric vehicle 100, can reduce already-limited power reserves stored in the batteries of the battery electric vehicle 100. It is therefore desirable to implement a control method, such as the methods disclosed herein, to ensure that the hydraulic pump 302 (or other electrically powered heating device, such as an electrically powered heater) is run in such a fashion as to present or minimize the consumption of battery power.

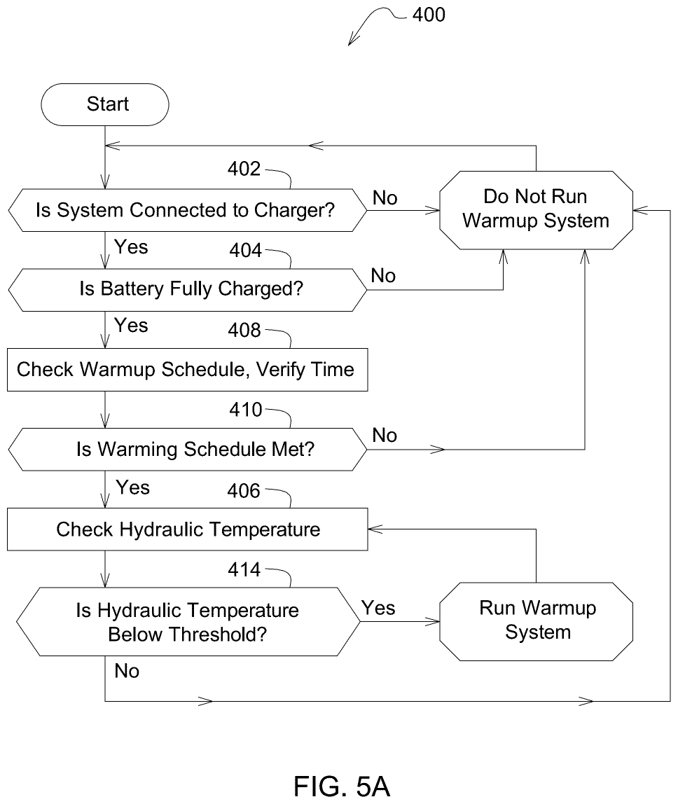

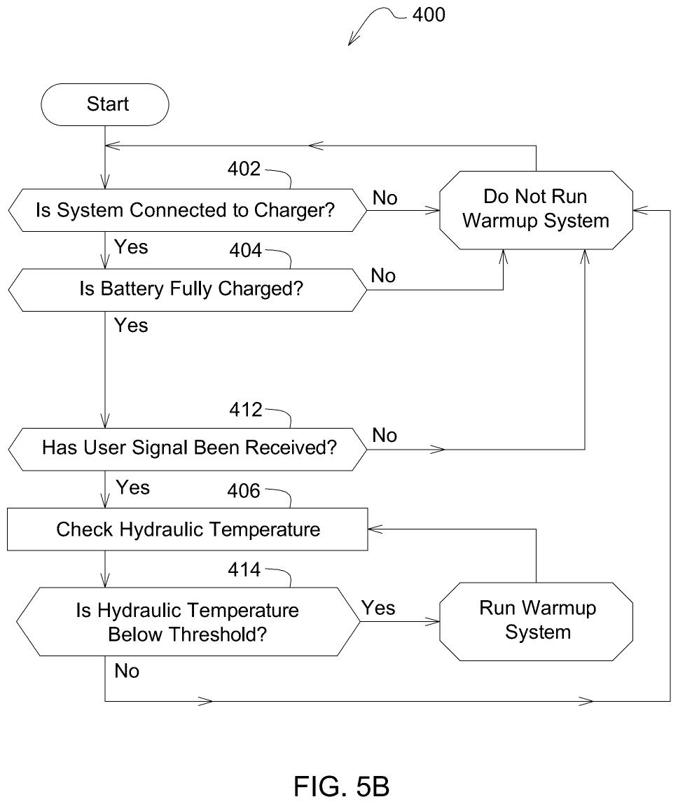

An example thermal control method 400, according to one aspect of the present disclosure, is shown in FIGS. 5A and 5B. While the thermal control method 400 is discussed herein in relation to a method for heating a hydraulic system, it is to be appreciated that the core logic of the thermal control method 400 is applicable to any auxiliary system of a battery electric vehicle 100 that may benefit from or otherwise employ a heating and/or warmup cycle prior to use. Additionally, which the thermal control method 400 is primarily described herein with respect to the control of a heating system using a hydraulic pump, such as the hydraulic pump 302 previously described to force a hydraulic fluid through a restrictive passage, such as the restrictive passage 306 previously described, similar logic and steps may apply to alternate heating systems, such as those reliant on electrically powered heating elements.

According to one aspect of the present disclosure, the thermal control method 400 includes a charger connection check step 402. During the charger connection check step 402, the controller 230 receives a charger connection signal 236S from the charger electrical connection sensor 236 determining whether the battery electric vehicle 100 is electrically connected to a charging source. According to one aspect of the present disclosure, if the battery electric vehicle 100 is not electrically connected to a charging source, then the heating device (such as the hydraulic pump 302) is not activated because doing so would instead draw battery power. If the battery electric vehicle 100 is electrically connected to a charging source, one or more additional checks may be made to confirm whether the heating device (such as the hydraulic pump 302) may be activated, or the heating device may be activated.

According to one aspect of the present disclosure, the thermal control method 400 can also include a battery charge check step 404, as shown in FIGS. 5A and 5B. During the battery charge check step 404, the controller 230 receives the battery charge signal 252S from the battery charge level sensor 252, which checks the charge state of the battery (for example, the battery module 144) of the battery electric vehicle 100. The controller 230 may compare the measured charge state of the battery against a target value, for example, 80% of maximum charge, 90% of maximum charge, or 100% of maximum charge. According to one aspect of the present disclosure, if the charge state of the battery is lower than the target value, then the heating device (such as the hydraulic pump 302) is not activated, because it is instead preferred to use available electrical power to charge the battery. Likewise, if the charge state of the battery is greater than or equal to the target value (that is, greater than or equal to 80% of maximum charge, greater than or equal to 90% of maximum charge, or greater than or equal to maximum charge), then one or more additional checks may be made to confirm whether the heating device (such as the hydraulic pump 302) may be activated, or the heating device may be activated.

It will be appreciated that in some examples of the thermal control method 400, a battery check may be omitted. For example, it may be determined in some circumstances, that heating the thermal control system 300 has a higher priority than charging the battery, and in such examples, low or comparatively low battery charge will not prevent the activation of the hydraulic pump 302 or other heating device.

According to some aspects of the present disclosure, the thermal control method 400 may also include a system temperature measurement step 406, as shown in FIG. 5A. During the auxiliary system temperature measurement step 406, an auxiliary system temperature sensor (such as the hydraulic temperature sensor 232) measures the temperature of the auxiliary system, such as the thermal control system 300 disclosed herein, and transmits the measured temperature of the auxiliary system to the controller 230 via a signal such as the hydraulic temperature signal 232S. The controller 230 can compare the measured temperature of the auxiliary system against a target temperature (step 414, as shown in FIGS. 5A and 5B). According to one aspect of the present disclosure, if the measured temperature of the auxiliary system is higher than or equal to the target temperature, the heating device (such as the hydraulic pump 302) is not activated. Likewise, if the auxiliary system temperature is below the target temperature, then one or more additional checks may be made to confirm whether the heating device (such as the hydraulic pump 302) may be activated, or the heating device may be activated.

According to some aspects of the present disclosure, the thermal control method 400 can also include a scheduling step 408. In such aspects of the present disclosure, the battery electric vehicle 100 may have a defined use schedule, comprising, for example, a use period, where the vehicle is scheduled for use (that is, moving and performing work), an idle period, where no use is scheduled for the vehicle, and a pre-use period preceding the use period, where tasks such as warming up the auxiliary system can be performed. During the scheduling step 408 the clock or chronometer 254 is used to determine the time of day. The chronometer signal 254S communicates the time of day to the controller 230, which checks the time of day against the defined use schedule.

In such examples, the activation of the heating device (such as the hydraulic pump 302) can be designated to run during some or of the all idle period, the pre-use period, or the use period. Accordingly, the thermal control method 400 can further include checking the time of day, as measured by the clock or chronometer 254 against the use schedule to determine if the activation of the heating device (such as the hydraulic pump 302) is allowed at the presently measured time, as indicated by schedule checking step 410.

For example, it may be determined that, to conserve power, the heating device (such as the hydraulic pump 302) should not be run until just before the battery electric vehicle 100 is scheduled to be used. In such instances, the heating device may be prevented from running during the idle period. Likewise, it may be determined that, once the machine is in use doing work, no additional warming of the auxiliary system is needed, and accordingly, the heating device may be prevented from running during the use period. In such an example, the chronometer 254 would measure the time of day, and the controller 230 would compare the time against the use schedule. If the time of day corresponds with either the idle period or the use period, then the heating device (such as the hydraulic pump 302) is not activated. Likewise, if the time of day corresponds to the pre-use period, then one or more additional checks may be made to confirm whether the heating device (such as the hydraulic pump 302) may be activated, or the heating device may be activated.

In some examples, a fixed time limit may be imposed on the pre-use period, to further conserve power. For example, the pre-use period according to some examples may be no greater than 30 minutes, no greater than 20 minutes, no greater than 15 minutes, or no greater than 10 minutes. As will be readily appreciated by a person of skill in the art, the maximum duration of the pre-use period can be adjusted to be longer or shorter than the 10, 15, 20, or 30 minutes previously recited, depending on the specific configuration of the auxiliary system, the specific configuration of the heating method, and/or the environmental conditions. Advantageously, this ensures that the auxiliary system is not warmed up too far in advance of the use of the battery electric vehicle 100 and power is thereby conserved.

In other examples, in lieu of or in addition to the use of a clock or chronometer 254 and a predetermined use schedule, the scheduling step 408 and the schedule checking step 410 may be manually performed by a user. According to one aspect of the present disclosure, for example, the user may indicate a correct time for activating the heating device (such as the hydraulic pump 302) by sending a signal from a user interface. The user interface may be incorporated into the battery electric vehicle 100, such as in the control station 142, or may be separate from the battery electric vehicle 100, for example, located on a mobile device.

As shown in FIG. 5B, the thermal control method 400 can comprise a signaling step 412 in place of the scheduling step 408 and the schedule checking step 410. In such examples, the signaling step 412 includes receiving a signal from the signal source (that is, the user interface). The signal is received by the controller 230 and comprises one or more instructions to activate the heating device (such as the hydraulic pump 302), and if the other conditions for activating the heating device as disclosed herein are met, activating the heating device in response to the signal.

According to some aspects of the present disclosure, the heating device (such as the hydraulic pump 302) can be run for a predetermined time before it is deactivated. The predetermined time can be a minimum or a maximum time. The minimum and/or the maximum time may be selected or adjusted by an operator based on the specific configuration and requirements of the auxiliary system being controlled and any environmental factors which may require a longer heating device run time, or any considerations which may impose a maximum time on how long the heating device can be run.

According to some aspects of the present disclosure, the heating device can be deactivated when the battery electric is activated for work use by a user. In such cases, when the battery electric vehicle is activated for work use, it may no longer be necessary to run the auxiliary system independent of the work functions of the vehicle (for example, driving the vehicle and/or using the working tool of the vehicle), and so turning off an independent heating device can conserve power.

According to some aspects of the present disclosure, the thermal control method 400 can further comprise deactivating the heating device (such as the hydraulic pump 302) after the heating device has been activated, provided that one or more of the previously discussed conditions are no longer met. For example, the heating device (such as the hydraulic pump 302) can be deactivated once the auxiliary system temperature is greater than or equal to the target temperature, if the charge state of the battery is less than the target charge value, or if the battery electric vehicle 100 is no longer electrically connected to the charger. In some examples, the heating device (such as the hydraulic pump 302) can be deactivated because the time of day, as measured by the chronometer 254, no longer corresponds to a predetermined period in which the heating device should be run, or deactivated in response to a second signal (such as a shutdown signal) provided by the user through the user interface. In such examples, should the conditions previously discussed be met again at a later time, the auxiliary system can be reactivated.

It will be appreciated that, while the various steps of the thermal control method 400 discussed herein occurring before the activation of the heating device are presented in a certain order, the order in which any of these steps is performed may vary. That is, any step pertaining to a conditional requirement for the activation of the heating device may be performed before and/or alongside any other such step.

It will also be appreciated that, while the various steps of the thermal control method 400 disclosed herein are presented in relation to the warm up/heating cycle of a hydraulic system, a substantially similar set of steps and logic may be used for any auxiliary system of the battery electric vehicle 100 which requires a warm up period.

It will further be appreciated that, while the various steps of the thermal control method 400 disclosed herein are primarily presented in relation to a heating device comprising a hydraulic pump, as disclosed herein, the thermal control method 400 applies as well to systems including other heating devices, such as electrically powered heating elements.

Advantageously, the combination of features and methods as disclosed herein allow for an auxiliary system of a battery electric vehicle 100 to be brough to desired operational temperature prior to operating the battery electric vehicle 100, without depleting the battery charge of the battery electric vehicle 100.

Although there have been described particular embodiments of the present invention of a new and useful auxiliary systems and thermal management methods for the same, it is not intended that such references be construed as limitations upon the scope of this invention except as set forth in the following claims.

1. A thermal control method for an auxiliary system of a battery electric vehicle, comprising:
determining whether the battery electric vehicle is electrically connected to an electrical charger;
measuring a temperature of the auxiliary system;
comparing the measured temperature of the auxiliary system against a target temperature; and
activating a heating device configured to increase the temperature of the auxiliary system, when the measured temperature is less than the target temperature and when the electric vehicle is electrically connected to the electrical charger.

2. The thermal control method of claim 1, wherein the auxiliary system is a hydraulic system comprising a hydraulic fluid contained within a hydraulic loop.

3. The thermal control method of claim 2, wherein the heating device includes an electrically powered pump configured to induce a flow of the hydraulic fluid across a restrictive passage.

4. The thermal control method of claim 3, wherein the hydraulic loop comprises a valve and the restrictive passage is formed by placing the valve in a non-operational position.

5. The thermal control method of claim 2, wherein the heating device comprises one or more electrically powered heating elements in thermal communication with the hydraulic fluid.

6. The thermal control method of claim 1, further comprising checking a charge state of a battery of the battery electric vehicle, and activating the heating device when the battery charge is charged to a level of greater than or equal to 90% of a maximum charge.

7. The thermal control method of claim 6, wherein the heating device is activated when the battery is fully charged.

8. The thermal control method of claim 1, further comprising measuring a time of day, checking the time of day against a use schedule for the battery electric vehicle, wherein the use schedule comprises an idle period, a pre-use period, and a use period following the pre-use period, and wherein the heating device is activated during the pre-use period.

9. The thermal control method of claim 8, wherein the pre-use period has a duration of no greater than 15 minutes.

10. The thermal control method of claim 1, further comprising receiving a signal from a signal source, the signal comprising one or more instructions to activate the heating device, and activating the heating device in response to the signal.

11. The thermal control method of claim 1, wherein the step of measuring the temperature is performed when the battery electric vehicle is electrically connected to the electrical charger.

12. The thermal control method of claim 1, wherein activating the heating device comprises running the heating device for a period of at least a minimum heating time.

13. The thermal control method of claim 12, further comprising measuring the temperature of the auxiliary system after the heating device has been run for at least 15 minutes, and, if the temperature of the auxiliary system is lower than the target temperature, reactivating the heating device.

14. The thermal control method of claim 1, further comprising continually measuring the temperature of the auxiliary system after the heating device is activated, and wherein the heating device is kept active until the temperature of the auxiliary system is equal to or greater than the target temperature and reactivated when the temperature of the auxiliary system falls below the target temperature.

15. The thermal control method of claim 1, further comprising deactivating the heating device when the battery electric vehicle is turned on by a user.

16. A thermal control system for a hydraulic system of a battery electric vehicle, comprising:
a hydraulic pump configured to move a hydraulic fluid within the hydraulic system;
a temperature sensor configured to measure the temperature of the hydraulic fluid; and
a controller configured to:
identify when the battery electric vehicle is connected to a charging source,
identify the temperature of the hydraulic fluid;
compare the temperature of the hydraulic fluid to a target temperature; and
activate the hydraulic pump when the temperature of the hydraulic fluid is less than the target temperature and the battery electric vehicle is connected to a charging source.

17. The thermal control system of claim 16, further comprising:
a sensor to monitor a charge level of a battery module of the battery electric vehicle; and
wherein the controller is further configured such that when the battery module is not fully charged, the controller will not activate the hydraulic pump.

18. The thermal control system of claim 16, further comprising:
a receiver configured to receive a signal from a user interface, the signal comprising an instruction to activate the hydraulic pump; and
wherein the controller is further configured such that the hydraulic pump is not activated unless the signal is received.

19. The thermal control system of claim 16, further comprising:
a timer, and
wherein the controller records a use schedule for the battery electric vehicle, comprising an idle period, a use period, a pre-use period preceding the use period,
wherein the controller compares a time measured by the timer against the use schedule, and
wherein the controller activates the hydraulic pump during the pre-use period.
